(19) United States
(12) Patent Application Publication
(10) Pub. No.: US 2009/0014979 A1
(43) Pub. Date: Jan. 15, 2009

(54) Hand truck apparatus

(75) Inventors: Kim C. Snook, Saginaw, MI (US); Michael S. Spakowski, Saginaw, MI (US); George D. Gaines, Saginaw, MI (US)

Correspondence Address: JOHN MCCULLOCH, 5291 COLONY DRIVE NORTH,, STE. 1, SAGINAW, MI, 48638, US

(73) Assignee: KMD ENTERPRISES, L.L.C.

(21) Appl. No.: 11/827,030

(22) Filed: Jul. 10, 2007

(51) Int. Cl. B62B 1/14

(52) U.S. Cl. 280/200

(57) ABSTRACT

A hand truck has a conventional article supporting nose for supporting articles that are not cylindrical in configuration. An auxiliary support is provided to support, in conjunction with the nose, a cylindrical article from the bottom thereof. A clamp mechanism is provided to clamp the upper end of a cylindrical article to the hand truck. The auxiliary support and clamp mechanism are movable from active positions and inactive positions so as not to interfere with normal usage of the hand truck in transporting noncylindrical articles.

This invention relates to a wheeled hand truck especially adapted for use in selectively transporting either cylindrical or quadrangular articles.

### BACKGROUND OF THE INVENTION

Wheeled hand trucks conventionally are used in the transporting of beverages and containers therefor. Some containers, such as quadrangular cases for beverages such as beer and soft drinks, can be stacked and transported by means of a hand truck without difficulty. However, other containers, such as cylindrical casks or kegs, have a tendency to roll sideways relative to the hand truck, thereby requiring the use of straps or curvilinear truck frames to accommodate the cylindrical containers. In some instances wherein containers of both kinds are to be delivered to a single destination the deliverer makes use of a selected one of two different hand trucks, one of which is suitable for use with the cylindrical containers and the other of which is suitable for use with the quadrangular containers. The necessity of having to provide more than one hand truck not only is costly, but requires the storage of the extra hand truck in space which could be used more effectively for the beverage containers.

A principal object of the invention is to provide a single hand truck which is particularly well suited for selectively transporting either quadrangular or cylindrical containers.

### SUMMARY OF THE INVENTION

A hand truck constructed in accordance with the presently preferred embodiment of the invention comprises a frame having spaced apart generally upright side frame members joined by cross bars. At one end of the frame are mounted ground engageable wheels, and at the other end of the frame handles conventionally are provided. At the lower end of the frame is secured a forwardly projecting nose support member on which an article may be supported for transport. If the article to be supported is quadrangular, or has flat bottom and rear surfaces, such articles may simply be placed on the nose and, if desired, stacked one upon another. To transport such articles the frame is tipped rearwardly so as to lift the nose upwardly, thereby enabling the wheels to provide the sole engagement with the ground. Tipping of the frame rearwardly enables articles on the nose to bear against the frame and, if those surfaces which bear against the nose and the frame are relatively flat, the position of the article or articles is fairly stable.

Adjacent the wheeled end of the frame is an auxiliary support member adapted for use in supporting a cylindrical container of the kind having a rim at each of its opposite ends. The auxiliary support includes a body member one end of which is pivoted to the frame at a position substantially midway between the side frame members so as to be movable between forward and rearward positions. The body member has at its opposite end a lip which, conjointly with the nose, may provide support for the lower end of the cylindrical container, thereby inhibiting rolling movement of the cylindrical container laterally of the truck frame.

At a position above and remote from the nose is pivoted a clamp member for swinging movement from a rearward position to a forward position in which it overlies the upper end of a cylindrical container carried by the support nose. The clamp includes a part which is engageable with the inner surface of the rim at the upper end of the container. The clamp cooperates with the lip of the lower, auxiliary support member to inhibit rolling movement of the cylindrical container laterally of the truck frame, as well as forward tipping of such container.

Since both the lower auxiliary support and the upper clamp are pivotably movable between forwardly projecting and rearwardly extending positions relative to the frame, neither the auxiliary support nor the clamp interferes with the normal use of the hand truck in transporting quadrangular articles. However, the auxiliary support and the clamp may be swung to forwardly extending positions in which they grip the flanges at opposite ends of a cylindrical container and not only inhibit side-to-side rolling movement of such container relative to the frame, but also forward tipping of the container.

### THE DRAWINGS

The presently preferred embodiment of the invention is illustrated in the accompanying drawings wherein:

FIG. 1 is a fragmentary, front elevational view of the hand truck in condition to accommodate a cylindrical container;

FIG. 2 is a side elevational view, partly in section, illustrating the hand truck and a cylindrical container supported thereon; and

FIG. 3 is a fragmentary, side elevational view, on an enlarged scale, illustrating the auxiliary container support.

### THE PREFERRED EMBODIMENT

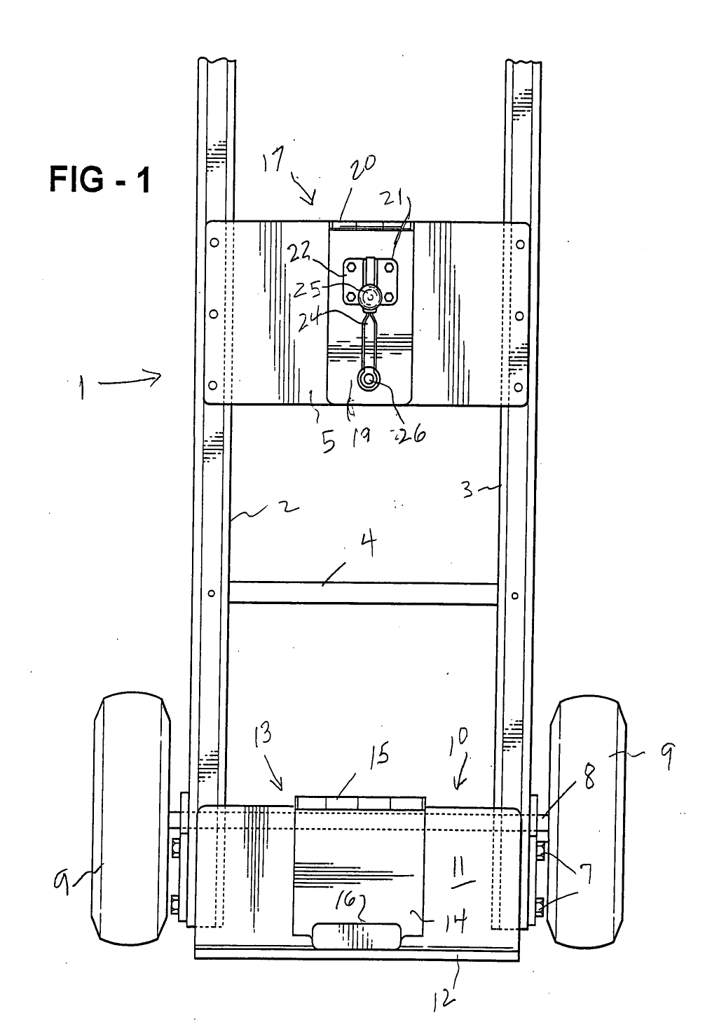

A hand truck constructed in accordance with the invention comprises a frame 1 composed of spaced apart, substantially parallel, elongate side frame members 2 and 3 joined at spaced intervals by a handle H and cross members, two of which are shown in FIG. 1 at 4 and 5.

Adjacent corresponding, lower ends of the frame members 2 and 3 are gussets 6 secured to the frame member by suitable means, such as bolts 7, and provided with bearings for journaling an axle 8 which spans the frame and is provided with ground engaging wheels 9.

Secured by welding or otherwise to the corresponding, lower ends of the frame members 2 and 3 is an L-shaped main article support member 10 having an upright plate 11 secured to the frame members and terminating at its lower end in a forwardly extending nose 12. An auxiliary or supplemental support 13 also is provided at the lower end of the truck frame and comprises a flat body member 14 pivoted at its upper end by a hinge 15 to the upper end of the plate 11. At the opposite end of the body member 14 is a reversely turned extension terminating in an upstanding lip 16. As is shown in FIG. 1, the auxiliary support 13 is positioned substantially midway between the opposite ends of the main support member 10.

Clamp means 17 is provided for use in conjunction with certain kinds of articles as will be explained subsequently. The clamp means comprises a pair of leaves 18 and 19 pivoted to one another at corresponding ends by a hinge 20. The leaf 18 is welded or otherwise secured to the frame cross member 5, whereas the leaf 19 is freely swingable about the axis of the hinge 20. Bolted or otherwise secured to the leaf 19 is a bracket 22 on which is pivoted a toggle clamp such as that manufactured by DE-STA-CO Products of Auburn Hills, Mich. The toggle clamp has toggle arms 23 and 24 pivoted to the bracket 22 and an actuating member 25 for manual operation. Adjustably accommodated at the free end of the toggle arm 24 is a threaded rod 26 fitted at one end with a clamp head or bearing member 27 which is adjustable axially of the arm 24 by rotation of the rod.

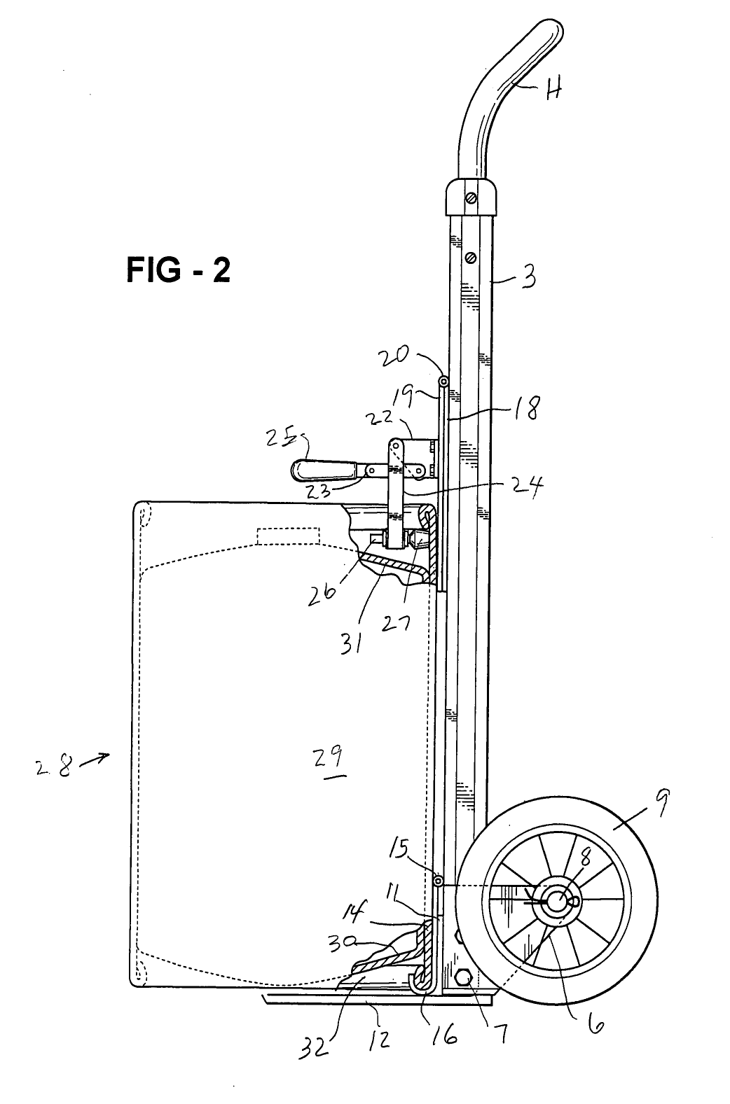

FIG. 2 illustrates a cylindrical container 28 of the kind with which the devices 13 and 17 are especially adapted for use. The container has a cylindrical wall 29 having at one end a bottom wall 30 and at the opposite end a top wall 31. The cylindrical wall 29 extends beyond both of the end walls 30 and 31 and its ends are rolled to form lower and upper rims 32 and 33, respectively. The container 28 corresponds to a conventional keg or a part keg of the kind typically used for containing draft beer.

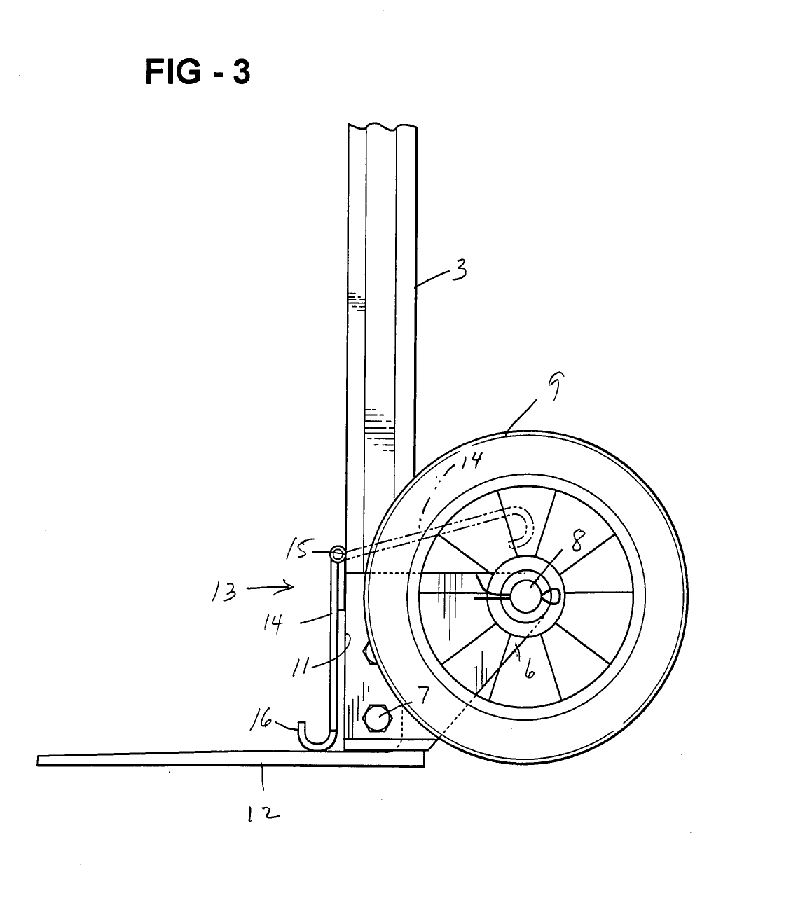

To condition the hand truck for use in transporting the container 28, the plate 14 of the auxiliary support 13 is rocked about the hinge 15 to the forwardly projecting position shown in FIGS. 1 and 2 and in full lines in FIG. 3. In this position the lip 16 extends forwardly of the plate 11 and overlies the nose 12. When the auxiliary support is in this position, the container 28 may be tipped so as to enable the nose of the hand truck to move beneath the container a distance sufficient to enable the lower rim 32 to overlie the lip 16. The container then may be returned to its normal, substantially vertical position so the lip 16 will bear against the inner surface of the lower rim 32 as is shown in FIG. 2. The side-to-side length of the lip 16 is such as to provide not only vertical support for the container 28, but also to inhibit any tendency on the part of the container to roll sideways as it is being transported.

The leaf 19 of the clamp 17 then may be swung about the hinge 20 to a forwardly projecting active position in which the clamp head 27 may bear against the inner surface of the upper rim 33 and the actuator 25 manipulated to effect clamping of the upper end of the container against the leaf 19.

In the described position of the container its lower rim will be supported on the nose plate 12 of the hand truck and the lip 16 with the latter in snug engagement with the inner surface of the lower rim 32. The clamp head 27 of the toggle clamp 17 will bear forcibly against the inner surface of the upper rim of the container. The gripping of the lower and upper rims by the auxiliary support 13 and the clamp 17 effectively will restrain any tendency on the part of the container to roll from side-to-side as it is transported by the hand truck, and the container also will be restrained against forward movement relative to the hand truck.

When the hand truck is to be used for transporting noncylindrical containers such as quadrangular boxes or cases, the auxiliary support 13 may be retracted or swung rearwardly as is indicated by chain lines in FIG. 3, and the leaf 19 of the clamp means 17 similarly may be swung about its hinge 20 so that the clamp occupies an inactive position at the rear of the hand truck. In these positions the auxiliary support and the clamp means present no obstacle to the use of the hand truck to transport articles that are not cylindrical. Suitable and conventional latches (not shown) may be used for releasably latching the members 13 and 17 in their retracted positions.

When a delivery truck is used for the delivery of full or empty containers of which some are quadrangular and some are cylindrical, the same hand truck according to the invention may be used for each kind of container. Consequently, only one hand truck is required to be carried on the delivery truck.

The disclosed embodiment is representative of a presently preferred form of the invention, but is intended to be illustrative rather than definitive thereof. The invention is defined in the claims.

We claim:

1. Hand truck apparatus comprising a frame having spaced apart substantially parallel frame members joined by cross members; ground engageable wheels; means mounting said wheels on said frame adjacent one end thereof; a main support member mounted on said frame at said one end thereof for supporting an article; an auxiliary support member mounted on said frame adjacent said one end of said frame and being cooperable with said main support member for conjointly supporting such article; and clamp means carried by said frame at a position remote from said one end thereof operable to apply a releasable clamping force on such article when the latter is supported by either or both of said support members.

2. The apparatus according to claim 1 wherein said main support member spans said frame members.

3. The apparatus according to claim 2 wherein said main support member has a substantially flat surface engagable by such article.

4. The apparatus according to claim 1 wherein said clamp means is mounted on one of said cross members of said frame.

5. The apparatus according to claim 1 wherein said clamp means is mounted on one of said cross members of said frame for adjustment between a first position in which said clamp member projects in one direction and overlies said main support member and a second position in which said clamp means extends in a direction opposite said one direction.

6. The apparatus according to claim 1 wherein said auxiliary support member is mounted on said frame for movements between a first position in which said auxiliary support member extends in one direction and overlies said main support member and a second position in which said auxiliary support member does not overlie said main support member and extends in a direction opposite said one direction.

7. The apparatus according to claim 1 wherein said main support member has a side-to-side length such as to span said frame members and wherein said auxiliary support member has a side-to-side length substantially less than that of said main support member.

8. The apparatus according to claim 7 wherein said auxiliary support member occupies a position substantially midway between opposite ends of said main support member.

9. The apparatus according to claim 8 wherein said clamp means is mounted on said frame between said frame members in a position substantially between opposite ends of said main support member.

10. Hand truck apparatus comprising a frame having spaced, substantially parallel frame members joined by cross members; means journaling ground engageable wheels on said frame at one end thereof; an article-supporting nose member carried by said frame at said one end thereof and projecting in a forward direction from said frame; a container-support member; and means mounting said container support member on said frame adjacent said one end thereof for movements between a first position in which said container support member overlies said nose member and a second position in which said container support member occupies a retracted position remote from said nose member, said container support member when in said first position being operable to supplement said nose member in providing support for such article and when in said second position providing no support for such article.

11. The apparatus according to claim 10 including clamp means and means mounting said clamp means on said frame in a position remote from said one end thereof for movements from an article clamping position overlying and spaced from said nose member and an inactive position in which said clamp means occupies a position extending rearwardly of said frame.

12. The apparatus according to claim 11 wherein said clamp means includes a bearing member movable into and out of clamping engagement with an article supported on said nose member.

13. The apparatus according to claim 10 wherein said support member comprises a body having opposite ends at one of which is an upturned lip adapted for engagement with an article on said nose member.

14. The apparatus according to claim 13 including hinge means connecting said body at the opposite end thereof to said frame for swinging movements of said support member between said article clamping position and said inactive position.

15. The apparatus according to claim 12 including hinge means connecting said body at the opposite end thereof to said frame.

16. The apparatus according to claim 13 wherein said body is connected to said frame substantially midway between said frame members.

17. The apparatus according to claim 15 including hinge means pivotally connecting said clamp means to said frame for pivotal movements between said first and second positions.

18. The apparatus according to claim 16 wherein said clamp means is connected to said frame substantially midway between said frame members.
